(19) United States
(12) Patent Application Publication
(10) Pub. No.: US 2013/0249741 A1
(43) Pub. Date: Sep. 26, 2013

(54) Antenna and Terminal with Anenna

(71) Applicant: Huawei Device Co., Ltd., Shenzhen (CN)

(72) Inventors: Hongyan Chen, Beijing (CN); Yafang Yu, Beijing (CN); Shuhui Sun, Shenzhen (CN)

(73) Assignee: Huawei Device Co., Ltd., Shenzhen (CN)

(21) Appl. No.: 13/899,805

(22) Filed: May 22, 2013

Related U.S. Application Data
(63) Continuation of application No. PCT/CN2011/081703, filed on Nov. 3, 2011.

(30) Foreign Application Priority Data
Nov. 22, 2010 (CN) 201010555656.1

(51) Int. Cl. H01Q 5/00

(52) U.S. Cl. CPC H01Q 5/0093
USPC 343/700 MS

(57) ABSTRACT

An antenna and a terminal with an antenna are disclosed. The antenna is a strip planar antenna, which includes an intermediate frequency branch, a high frequency branch and a low frequency branch, where the intermediate frequency branch, the high frequency branch and the low frequency branch are independent of one another, the high frequency branch and the low frequency branch encircle the intermediate frequency branch; a feed point connecting line is disposed on the intermediate frequency branch; a first ground point connecting line is disposed on the high frequency branch; a second ground point connecting line is disposed on the low frequency branch, and the feed point connecting line, the first ground point connecting line and the second ground point connecting line are located at the same side of the antenna.

### CROSS-REFERENCE TO RELATED APPLICATIONS

This application is a continuation of International Application No. PCT/CN2011/081703, filed on Nov. 3, 2011, which claims priority to Chinese Patent Application No. 201010555656.1, filed on Nov. 22, 2010, both of which are incorporated herein by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of antenna design, and in particular, to an antenna and a terminal with an antenna.

### BACKGROUND

At present, an antenna used in a terminal with an antenna such as a mobile phone and a data card is mostly a monopole antenna, an inverted-F antenna (IFA) or a planar inverted-F antenna (PIFA), and working frequency bands of each of the antennas are between 824 megahertz (MHz) and 960 MHz and between 1710 MHz and 2170 MHz.

In the process of implementing embodiments of the present invention, the inventors found that a high frequency resonance and a low frequency resonance of a conventional antenna may include three frequency bands, which are 1800 frequency band, 1900 frequency band and 2100 frequency band, respectively. As shown in FIG. 1, when echo loss of the antenna is tested, in S11 diagram, mark number 1 indicates the low frequency resonance part, mark numbers 3 and 4 indicate the high frequency resonance part, an obvious bump part 2 exists between the high frequency resonance and the low frequency resonance, and the antenna efficiency of the bump part 2 is generally relatively low. So the antenna has a frequency band gap between 960 MHz and 1710 MHz. How to add related applications of frequency bands between 960 MHz and 1710 MHz is a problem required to be solved.

### SUMMARY

An antenna provided by embodiments of the present invention is used for implementing the adding of related applications of frequency bands between 960 MHz and 1710 MHz.

To achieve the above objective, embodiments of the present invention adopt the following technical solutions.

An antenna, which is a planar antenna, includes an intermediate frequency branch, a high frequency branch and a low frequency branch, where the intermediate frequency branch, the high frequency branch and the low frequency branch are independent of one another, the high frequency branch and the low frequency branch encircle the intermediate frequency branch; a feed point connecting line is disposed on the intermediate frequency branch; a first ground point connecting line is disposed on the high frequency branch; a second ground point connecting line is disposed on the low frequency branch, and the feed point connecting line, the first ground point connecting line and the second ground point connecting line are located at the same side of the antenna.

A terminal with an antenna, includes a radio frequency unit, and the radio frequency unit of the terminal with an antenna includes the above antenna.

In the antenna and the terminal with an antenna provided by the embodiments of the present invention, the antenna includes an intermediate frequency branch, a high frequency branch and a low frequency branch, where the intermediate frequency branch, the high frequency branch and the low frequency branch are independent of one another, the high frequency branch and the low frequency branch encircle the intermediate frequency branch, the intermediate frequency branch, a feed point connecting line is disposed on the high frequency branch and the low frequency branch, a first ground point connecting line and a second ground point connecting line, respectively, so that three resonances are generated, which are a low frequency resonance, a high frequency resonance and an intermediate resonance, respectively. Therefore, a resonance with a quite wide wide-band is generated. When echo loss of the antenna is tested, an echogram in which no obvious bump exists among the three resonances may be obtained, as shown in FIG. 2, so that the antenna not only can work on a frequency band of 824 MHz-960 MHz and a frequency band of 1710 MHz-2170 MHz, but also can work on a frequency band of 960 MHz-1710 MHz.

### BRIEF DESCRIPTION OF THE DRAWINGS

FIG. 1 is an S11 diagram for an antenna to perform echo loss testing in the prior art;

FIG. 2 is an S11 diagram for an antenna to perform echo loss testing according to an embodiment of the present invention;

FIG. 3 is a schematic structural diagram 1 of an antenna according to an embodiment of the present invention;

FIG. 4 is a schematic structural diagram 2 of an antenna according to an embodiment of the present invention;

FIG. 5 is a schematic structural diagram 1 of an antenna according to another embodiment of the present invention;

FIG. 6 is a schematic structural diagram 2 of an antenna according to another embodiment of the present invention;

FIG. 7 is a schematic structural diagram 3 of an antenna according to another embodiment of the present invention;

FIG. 8 is a schematic structural diagram 4 of an antenna according to another embodiment of the present invention; and

FIG. 9 is a block diagram of functions of a mobile phone according to an embodiment of the present invention.

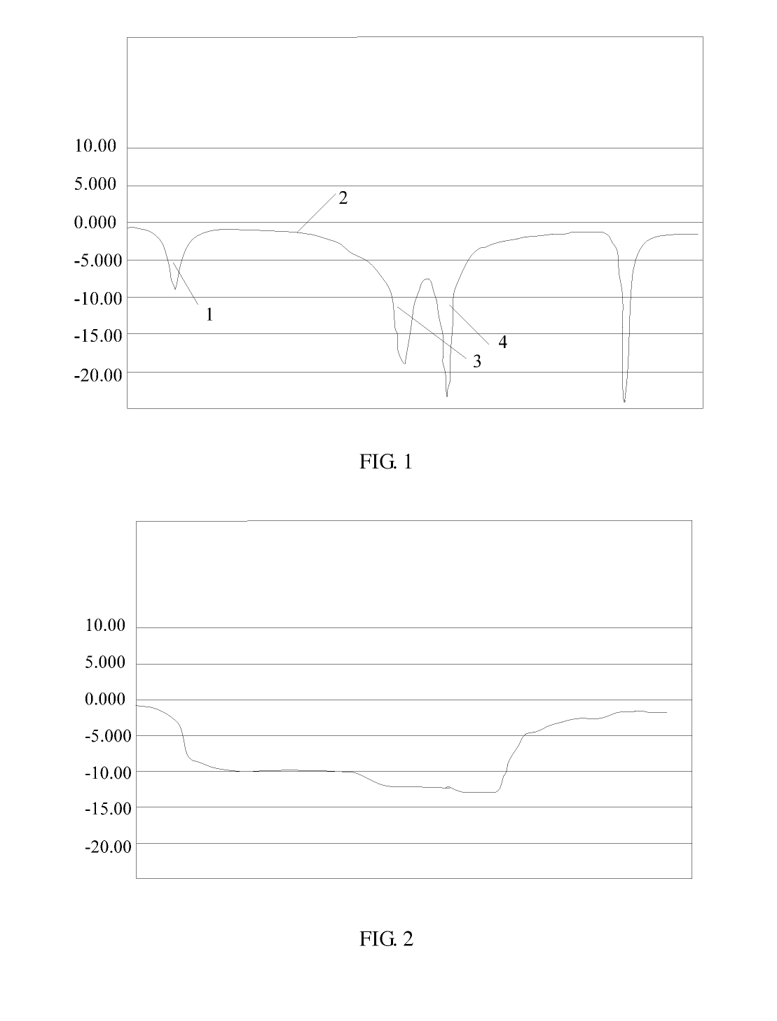

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiment of the present invention without creative efforts shall fall within the protection scope of the present invention.

In order to implement the adding of related applications of frequency bands between 960 MHz and 1710 MHz for an antenna, embodiments of the present invention provide an antenna and a terminal with an antenna.

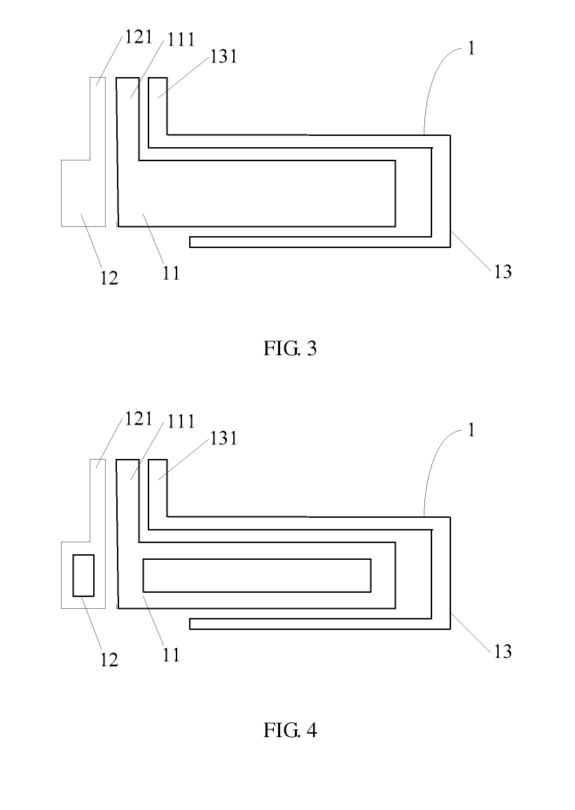

As shown in FIG. 3, an antenna provided by an embodiment of the present invention is a planar antenna 1 and includes an intermediate frequency branch 11, a high frequency branch 12 and a low frequency branch 13, where the intermediate frequency branch 11, the high frequency branch 12 and the low frequency branch 13 are independent of one another, the high frequency branch 12 and the low frequency branch 13 encircle the intermediate frequency branch 11; a feed point connecting line 111 is disposed on the intermediate frequency branch 11; a first ground point connecting line 121 is disposed on the high frequency branch 12; a second ground point connecting line 131 is disposed on the low frequency branch 13, and the feed point connecting line 111, the first ground point connecting line 121 and the second ground point connecting line 131 are located at the same side of the antenna 1.

As shown in FIG. 4, furthermore, in order to reduce the area of the branches, the intermediate frequency branch 11 may be a hollowed-out intermediate frequency branch and the high frequency branch 12 may be a hollowed-out high frequency branch.

In the antenna provided by the embodiment of the present invention, the antenna includes an intermediate frequency branch, a high frequency branch and a low frequency branch, where the intermediate frequency branch, the high frequency branch and the low frequency branch are independent of one another, the high frequency branch and the low frequency branch encircle the intermediate frequency branch, the intermediate frequency branch, a feed point connecting line is disposed on the high frequency branch and the low frequency branch, a first ground point connecting line and a second ground point connecting line, respectively, so that three resonances are generated, which are a low frequency resonance, a high frequency resonance and an intermediate resonance, respectively. Therefore, a resonance with a quite wide wide-band is generated. When echo loss of the antenna is tested, an echogram in which no obvious bump exists among the three resonances may be obtained, as shown in FIG. 2, so that the antenna not only can work on a frequency band of 824 MHz-960 MHz and a frequency band of 1710 MHz-2170 MHz, but also can work on a frequency band of 960 MHz-1710 MHz.

In order to enable persons of skill in the art to understand the technical solutions provided by the embodiment of the present invention more clearly, the antenna provided by the embodiment of the present invention is illustrated below in detail through specific embodiments.

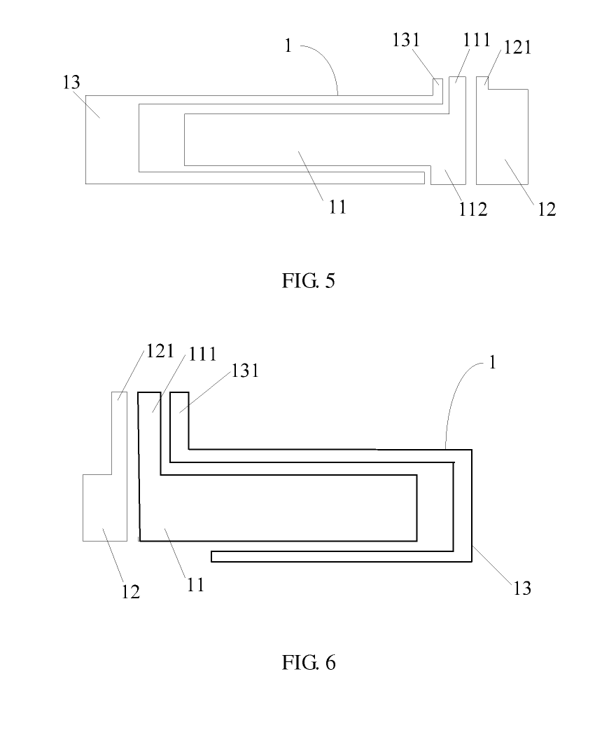

As shown in FIG. 5, for an antenna provided by another embodiment of the present invention, the antenna 1 is a planar antenna and includes an intermediate frequency branch 11, a high frequency branch 12 and a low frequency branch 13, where both the intermediate frequency branch 11 and the high frequency branch 12 are in a surface shape, and the low frequency branch 13 is in a polygonal-line shape.

The intermediate frequency branch 11, the high frequency branch 12 and the low frequency branch 13 are independent of one another, the high frequency branch 12 and the low frequency branch 13 encircle the intermediate frequency branch 11; a feed point connecting line 111 is disposed on the intermediate frequency branch 11; a first ground point connecting line 121 is disposed on the high frequency branch 12; a second ground point connecting line 131 is disposed on the low frequency branch 13, and the feed point connecting line 111, the first ground point connecting line 121 and the second ground point connecting line 131 are located at the same side of the antenna.

Furthermore, in order to make an antenna bandwidth better, a projection 112 is disposed on the intermediate frequency branch 11 and is located between the high frequency branch 12 and the low frequency branch 13, thereby separating the high frequency branch 12 from the low frequency branch 13, a cabling 112 is located at one side of the intermediate frequency branch 11 opposite to the feed point connecting line 111.

Furthermore, in order to reduce the area of the branches, the intermediate frequency branch 11 may be a hollowed-out intermediate frequency branch and the high frequency branch 12 may be a hollowed-out high frequency branch.

It should be noted that, the antenna is a passive device closely related to surroundings, on the premise that the intermediate frequency branch, the high frequency branch and the low frequency branch are independent of one another, the high frequency branch and the low frequency branch encircle the intermediate frequency branch, and the feed point connecting line, the first ground point connecting line and the second ground point connecting line are located at the same side of the antenna, the planar structure of the antenna is closely related to the difference of a structural support where the antenna is located.

Specifically, the specific shape of each branch of the antenna includes, but is not limited to, the antenna of the following embodiments.

(1) The antenna includes an intermediate frequency branch, a high frequency branch and a low frequency branch, where both the intermediate frequency branch and the high frequency branch are in an elongate surface shape, the intermediate frequency branch, the high frequency branch and the low frequency branch are independent of one another, and the high frequency branch and the low frequency branch encircle the intermediate frequency branch. A feed point connecting line is disposed on the intermediate frequency branch; a first ground point connecting line is disposed on the high frequency branch; a second ground point connecting line is disposed on the low frequency branch, and the feed point connecting line, the first ground point connecting line and the second ground point connecting line are located at the same side of the antenna.

When both the intermediate frequency branch and the high frequency branch are in an elongate surface shape, the specific shape of each branch of the antenna includes, but is not limited to, the antenna of the following embodiments.

(a) As shown in FIG. 6, both the intermediate frequency branch 11 and the high frequency branch 12 are rectangular, the intermediate frequency branch 11 and the high frequency branch 12 are arranged side by side, and one relatively short side of the intermediate frequency branch 11 is corresponding to one relatively long side of the high frequency branch 12. The low frequency branch 13 is in a polygonal-line shape, the polygonal-line low frequency branch 13 may be in a U-shape with a straight bottom, thereby achieving the objective that the low frequency branch and the high frequency branch encircle the intermediate frequency branch therein.

In this embodiment, when efficiency testing is performed on the antenna shown in FIG. 6, an Antenna Efficiency Table 1 shown in Table 1 is obtained.

TABLE 1
Antenna Efficiency Table 1
Frequency Point Value

| Frequency (MHz) | Efficiency (%) |
|---|---|
| 824 | 47.41 |
| 844 | 51.71 |
| 864 | 52.74 |
| 884 | 56.47 |
| 904 | 55.68 |
| 924 | 53.53 |
| 944 | 55.37 |
| 964 | 57.88 |
| 984 | 60.03 |
| 1004 | 58.04 |
| 1024 | 52.20 |
| 1044 | 46.83 |
| 1064 | 40.69 |
| 1084 | 41.47 |
| 1104 | 40.98 |
| 1124 | 41.88 |
| 1144 | 44.78 |
| 1164 | 49.43 |
| 1184 | 53.98 |
| 1204 | 57.28 |
| 1224 | 58.68 |
| 1244 | 61.10 |
| 1264 | 61.47 |
| 1284 | 60.49 |
| 1304 | 60.11 |
| 1324 | 58.67 |
| 1344 | 54.20 |
| 1364 | 54.41 |
| 1384 | 53.14 |
| 1404 | 52.33 |
| 1424 | 51.63 |
| 1444 | 50.19 |
| 1464 | 49.78 |
| 1484 | 51.44 |
| 1504 | 51.40 |
| 1524 | 51.23 |
| 1544 | 51.21 |
| 1564 | 51.70 |
| 1584 | 52.31 |
| 1604 | 54.36 |
| 1624 | 56.06 |
| 1644 | 56.78 |
| 1664 | 59.04 |
| 1684 | 62.21 |
| 1704 | 64.48 |
| 1724 | 67.73 |
| 1744 | 69.44 |
| 1764 | 70.20 |
| 1784 | 71.37 |
| 1804 | 73.79 |
| 1824 | 75.95 |
| 1844 | 76.70 |
| 1864 | 76.44 |
| 1884 | 76.25 |
| 1904 | 74.62 |
| 1924 | 72.85 |
| 1944 | 71.84 |
| 1964 | 70.50 |
| 1984 | 65.64 |
| 2004 | 61.51 |
| 2024 | 55.41 |
| 2044 | 50.40 |
| 2064 | 53.48 |
| 2084 | 55.71 |
| 2104 | 53.77 |
| 2124 | 50.10 |
| 2144 | 48.35 |
| 2164 | 47.56 |
| 2170 | 47.49 |
| 2190 | 46.16 |

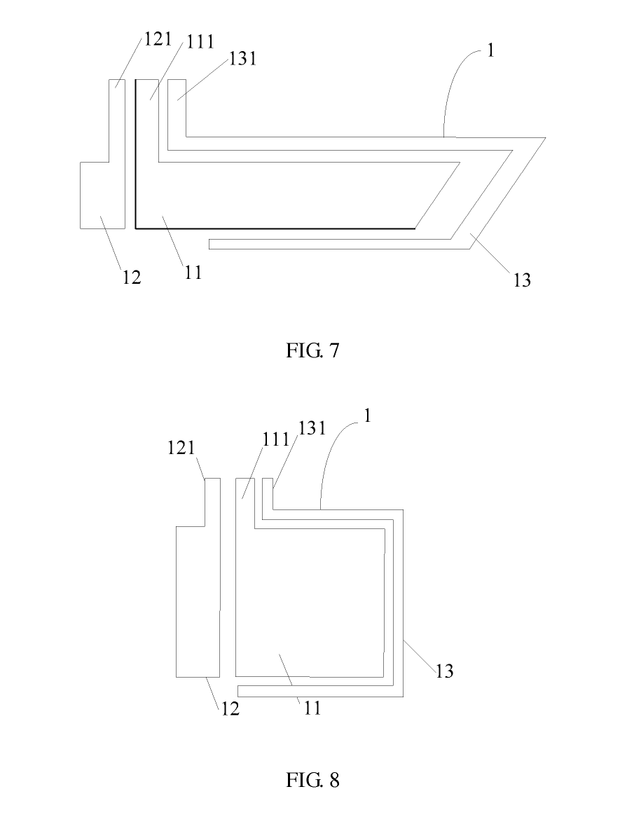

(b) As shown in FIG. 7, the elongate surface shape includes a right-angled trapezoid and a rectangle. At this time, the intermediate frequency branch 11 is a trapezoid, the high frequency branch 12 is a rectangle and a right-angled leg of the intermediate frequency branch 11 is adjacent to one relatively long side of the high frequency branch 12. The low frequency branch 13 is in a U-shape, and the bottom of the U-shape may be parallel to the oblique leg of the intermediate frequency branch 11. So an area with a long distance from the ground may be effectively used.

When efficiency testing is performed on the antenna shown in FIG. 7, the testing results are as shown in Table 2.

TABLE 2
Antenna Efficiency Table 2
Frequency Point Value

| Frequency (MHz) | Efficiency (%) |
|---|---|
| 824 | 37.48 |
| 844 | 51.49 |
| 864 | 58.59 |
| 884 | 63.56 |
| 904 | 63.63 |
| 924 | 60.00 |
| 944 | 59.75 |
| 960 | 57.36 |
| 980 | 56.77 |
| 1010 | 53.35 |
| 1040 | 51.44 |
| 1070 | 46.31 |
| 1100 | 47.79 |
| 1130 | 52.49 |
| 1160 | 56.62 |
| 1190 | 58.58 |
| 1220 | 58.07 |
| 1250 | 55.88 |
| 1280 | 53.66 |
| 1310 | 53.42 |
| 1340 | 53.36 |
| 1370 | 56.35 |
| 1400 | 57.66 |
| 1430 | 61.02 |
| 1460 | 64.38 |
| 1490 | 49.88 |
| 1520 | 58.27 |
| 1550 | 63.76 |
| 1580 | 66.47 |
| 1610 | 64.66 |
| 1640 | 64.55 |
| 1670 | 67.24 |
| 1700 | 67.47 |
| 1730 | 68.34 |
| 1760 | 67.66 |
| 1790 | 67.22 |
| 1820 | 62.62 |
| 1850 | 57.53 |
| 1880 | 70.51 |
| 1910 | 74.53 |
| 1940 | 79.82 |
| 1970 | 80.59 |
| 2000 | 76.91 |
| 2030 | 74.06 |
| 2060 | 71.79 |
| 2090 | 68.34 |
| 2120 | 66.63 |
| 2150 | 65.50 |
| 2170 | 62.59 |

According to Table 1 and Table 2, it may be obtained that the working efficiencies of 824 MHz-2170 MHz of the antennas are all over 40%, so that the antenna not only can work on a frequency band of 824 MHz-960 MHz and a frequency band of 1710 MHz-2170 MHz, but also can work on a frequency band of 960 MHz-1710 MHz.

It should be noted that, when the intermediate frequency branch is in an elongate surface shape, one side of the intermediate frequency branch adjacent to the low frequency branch may be in an arc shape or polygonal-line shape, which is not described again herein.

(2) As shown in FIG. 8, the antenna 1 includes an intermediate frequency branch 11, a high frequency branch 12 and a low frequency branch 13, where the intermediate frequency branch 11 is in a square shape, the high frequency branch 12 is in an elongate surface shape, the low frequency branch 13 is in an polygonal-line shape, the intermediate frequency branch 11, the high frequency branch 12 and the low frequency branch 13 are independent of one another, the intermediate frequency branch 11 and the high frequency 12 are arranged side by side, one side of the intermediate frequency branch 11 is adjacent to one relatively long side of the high frequency branch 12, and the high frequency branch 12 and the low frequency branch 13 encircle the intermediate frequency branch 11. A feed point connecting line 111 is disposed on the intermediate frequency branch 11; a first ground point connecting line 121 is disposed on the high frequency branch 12; a second ground point connecting line 131 is disposed on the low frequency branch 13, and the feed point connecting line 111, the first ground point connecting line 121 and the second ground point connecting line 131 are located at the same side of the antenna 1.

In addition, in the above embodiment, the low frequency branch 13 may also be in a U-shape with an arc-shaped bottom instead of being in a polygonal-line shape.

In the antenna provided by the embodiment of the present invention, the antenna includes an intermediate frequency branch, a high frequency branch and a low frequency branch, the intermediate frequency branch, the high frequency branch and the low frequency branch are independent of one another, the high frequency branch and the low frequency branch encircle the intermediate frequency branch, the intermediate frequency branch, a feed point connecting line is disposed on the high frequency branch and the low frequency branch, a first ground point connecting line and a second ground point connecting line, respectively, so that three resonances are generated, which are a low frequency resonance, a high frequency resonance and an intermediate resonance, respectively. Therefore, a resonance with a quite wide wide-band is generated, and no obvious bump exists among the three resonances, so that the antenna not only can work on a frequency band of 824 MHz-960 MHz and a frequency band of 1710 MHz-2170 MHz, but also can work on a frequency band of 960 MHz-1710 MHz.

A terminal with an antenna provided by the embodiment of the present invention includes a radio frequency unit, where the radio frequency unit of the terminal with an antenna includes an antenna, and the antenna includes an intermediate frequency branch, a high frequency branch and a low frequency branch, where the intermediate frequency branch, the high frequency branch and the low frequency branch are independent of one another, the high frequency branch and the low frequency branch encircle the intermediate frequency branch; a feed point connecting line is disposed on the intermediate frequency branch; a first ground point connecting line is disposed on the high frequency branch; a second ground point connecting line is disposed on the low frequency branch, and the feed point connecting line, the first ground point connecting line and the second ground point connecting line are located at the same side of the antenna.

In this embodiment, both the intermediate frequency branch and the high frequency branch are in a surface shape and the low frequency branch is in a polygonal-line shape.

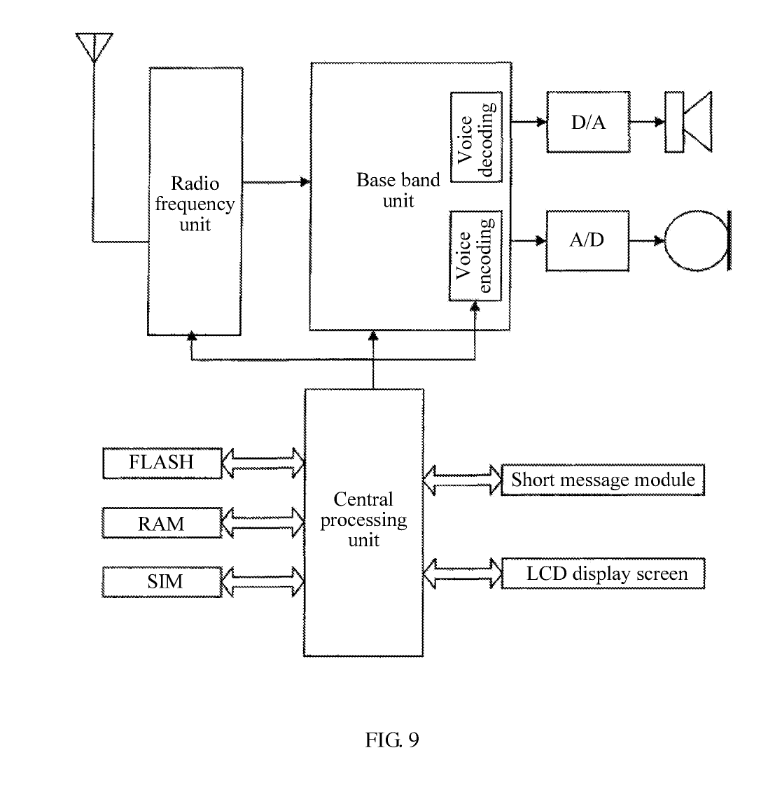

As shown in FIG. 9, taking a mobile phone terminal as an example, a conventional mobile phone terminal mainly includes: a central processing unit, a radio frequency unit and a base band circuit, where the radio frequency unit and the base band circuit are coupled with the central processing unit. Besides, the conventional mobile phone terminal further includes a subscriber identity module (SIM) card connected to the central processing unit, a storage device (such as flash memory and random-access memory (RAM)), a short message module and a liquid-crystal display (LCD) screen, and so on. The mobile phone of the embodiment of the present invention adopts the above antenna structure.

In the terminal with an antenna provided by the embodiment of the present invention, the antenna includes an intermediate frequency branch, a high frequency branch and a low frequency branch, where the intermediate frequency branch, the high frequency branch and the low frequency branch are independent of one another, the intermediate frequency branch, a feed point connecting line is disposed on the high frequency branch and the low frequency branch, a first ground point connecting line and a second ground point connecting line, respectively, so that three resonances are generated, which are a low frequency resonance, a high frequency resonance and an intermediate resonance, respectively. Therefore, a resonance with a quite wide wide-band is generated, and no obvious bump exists among the three resonances, so that the antenna not only can work on a frequency band of 824 MHz-960 MHz and a frequency band of 1710 MHz-2170 MHz, but also can work on a frequency band of 960 MHz-1710 MHz.

The antenna and the terminal with an antenna provided by the embodiments of the present invention can be applied to a device using an antenna for communication.

The foregoing descriptions are merely specific embodiments of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

What is claimed is:

1. A planar antenna comprising:
an intermediate frequency branch;
a high frequency branch;
a low frequency branch, wherein the intermediate frequency branch, the high frequency branch, and the low frequency branch are independent of one another, and wherein the high frequency branch and the low frequency branch encircle the intermediate frequency branch;
a feed point connecting line disposed on the intermediate frequency branch;
a first ground point connecting line disposed on the high frequency branch; and
a second ground point connecting line disposed on the low frequency branch, wherein the feed point connecting line, the first ground point connecting line, and the second ground point connecting line are located at a same side of the planar antenna.

2. The planar antenna according to claim 1, wherein both the intermediate frequency branch and the high frequency branch are in a surface shape, and wherein the low frequency branch is in a U-shape with an arc-shaped bottom or in a polygonal-line shape.

3. The planar antenna according to claim 2, wherein both the intermediate frequency branch and the high frequency branch are in an elongate surface shape, wherein the intermediate frequency branch and the high frequency branch are arranged side by side, and wherein one relatively short side of the intermediate frequency branch is adjacent to one relatively long side of the high frequency branch.

4. The planar antenna according to claim 2, wherein the intermediate frequency branch is in a square shape, wherein the high frequency branch is in an elongate surface shape, wherein the intermediate frequency branch and the high frequency branch are arranged side by side, and wherein one side of the intermediate frequency branch is adjacent to one relatively long side of the high frequency branch.

5. The planar antenna according to claim 1, wherein the intermediate frequency branch comprises a hollowed-out intermediate frequency branch.

6. The planar antenna according to claim 5, wherein the high frequency branch comprises a hollowed-out high frequency branch.

7. The planar antenna according to claim 1, wherein a projection is disposed on the intermediate frequency branch and is located between the high frequency branch and the low frequency branch, and wherein the projection is located at one side of the intermediate frequency branch opposite to the feed point connecting line.

8. The planar antenna according to claim 2, wherein a projection is disposed on the intermediate frequency branch and is located between the high frequency branch and the low frequency branch, and wherein the projection is located at one side of the intermediate frequency branch opposite to the feed point connecting line.

9. The planar antenna according to claim 3, wherein a projection is disposed on the intermediate frequency branch and is located between the high frequency branch and the low frequency branch, and wherein the projection is located at one side of the intermediate frequency branch opposite to the feed point connecting line.

10. The planar antenna according to claim 6, wherein a projection is disposed on the intermediate frequency branch and is located between the high frequency branch and the low frequency branch, and wherein the projection is located at one side of the intermediate frequency branch opposite to the feed point connecting line.

11. A terminal comprising
a radio frequency unit, wherein the radio frequency unit of the terminal comprises a planar antenna, wherein the planar antenna comprises an intermediate frequency branch, a high frequency branch, and a low frequency branch, wherein the intermediate frequency branch, the high frequency branch, and the low frequency branch are independent of one another, and wherein the high frequency branch and the low frequency branch encircle the intermediate frequency branch;
a feed point connecting line disposed on the intermediate frequency branch;
a first ground point connecting line disposed on the high frequency branch;
a second ground point connecting line disposed on the low frequency branch, wherein the feed point connecting line, the first ground point connecting line, and the second ground point connecting line are located at a same side of the planar antenna.

12. The terminal according to claim 11, wherein both the intermediate frequency branch and the high frequency branch are in a surface shape, and wherein the low frequency branch is in a U-shape with an arc-shaped bottom or in a polygonal-line shape.

13. The terminal according to claim 12, wherein both the intermediate frequency branch and the high frequency branch are in an elongate surface shape, wherein the intermediate frequency branch and the high frequency branch are arranged side by side, and wherein one relatively short side of the intermediate frequency branch is adjacent to one relatively long side of the high frequency branch.

14. The terminal according to claim 12, wherein the intermediate frequency branch is in a square shape, wherein the high frequency branch is in an elongate surface shape, wherein the intermediate frequency branch and the high frequency branch are arranged side by side, and wherein one side of the intermediate frequency branch is adjacent to one relatively long side of the high frequency branch.

15. The terminal according to claim 11, wherein the intermediate frequency branch comprises a hollowed-out intermediate frequency branch.

16. The terminal according to claim 15, wherein the high frequency branch comprises a hollowed-out high frequency branch.

17. The terminal according to claim 11, wherein a projection is disposed on the intermediate frequency branch and is located between the high frequency branch and the low frequency branch, and wherein the projection is located at one side of the intermediate frequency branch opposite to the feed point connecting line.

18. The terminal according to claim 12, wherein a projection is disposed on the intermediate frequency branch and is located between the high frequency branch and the low frequency branch, and wherein the projection is located at one side of the intermediate frequency branch opposite to the feed point connecting line.

19. The terminal according to claim 13, wherein a projection is disposed on the intermediate frequency branch and is located between the high frequency branch and the low frequency branch, and wherein the projection is located at one side of the intermediate frequency branch opposite to the feed point connecting line.

20. The terminal according to claim 16, wherein a projection is disposed on the intermediate frequency branch and is located between the high frequency branch and the low frequency branch, and wherein the projection is located at one side of the intermediate frequency branch opposite to the feed point connecting line.
